(19) United States
(12) Patent Application Publication
(10) Pub. No.: US 2013/0007428 A1
(43) Pub. Date: Jan. 3, 2013

(54) SYSTEM AND METHOD FOR CUSTOMIZED CONFIGURATION OF INFORMATION HANDLING SYSTEMS

(75) Inventors: Farzad Khosrowpour, Pflugerville, TX (US); Donald W. Gerhart, Salado, TX (US); Mukund Purshottam Khatri, Austin, TX (US)

(73) Assignee: DELL PRODUCTS L.P., Round Rock, TX (US)

(21) Appl. No.: 13/174,407

(22) Filed: Jun. 30, 2011

(51) Int. Cl. G06F 15/177

(52) U.S. Cl. 713/1

(57) ABSTRACT

In accordance with embodiments of the present disclosure, a method may include determining if personality information associated with an information handling resource of an information handling system is present on a personality module of the information handling system. The method may also include modifying the information handling resource or a second information handling resource to include the personality information in response to determining that the personality information associated with the information handling resource is present in the personality module. The method may further include executing the information handling resource or the second information handling resource as modified with the personality information.

### TECHNICAL FIELD

The present disclosure relates in general to information handling systems, and more particularly to customized configuration of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Oftentimes, various components of an information handling system may be “branded” with an identity of the manufacturer and/or seller of the information handling system such that when such components execute on an information handling system, such components may display to a display device associated with an information handling system a graphic or alphanumeric indication of the identity of the manufacturer and/or seller (e.g., a name, a mark, a logo, etc.).

Typically, a manufacturer may brand various components with its own identity. However, in some instances, a manufacturer may be a different entity than the seller, and a seller may desire to brand components of the information handling system with its own identity, rather than the identity of the manufacturer. Accordingly, the various components must be altered to remove the manufacturer's identity and add the seller's identity. Traditionally, this requires alteration of each component as initially installed on the information handling system, and alteration of each component each time the component is updated to a new version or revision (e.g., a firmware upgrade, BIOS upgrade, etc.). Such alterations may prove time consuming, expensive, and/or prone to error.

In addition to branding, a seller may also to desire to customize portions of components other than branding. Such vendor-specific customizations may also require alteration of each components as initially installed on the information handling system, and alteration of each component each time the component is updated to a new version or revision (e.g., a firmware upgrade, BIOS upgrade, etc.), which may also prove time consuming, expensive, and/or prone to error.

### SUMMARY

In accordance with the teachings of the present disclosure, the disadvantages and problems associated with vendor-specific customizations to information handling resources of an information handling system have been reduced or eliminated.

In accordance with embodiments of the present disclosure, an information handling system may include a personality module and an information handling resource communicatively coupled to the personality module. The personality module may have stored therein personality information associated with one or more information handling resources. The information handling resource may be configured to: determine if personality information associated with the information handling resource is present in the personality module, in response to determining that the personality information associated with the information handling resource is present in the personality module, modify itself or a second information handling resource to include the personality information, and execute the information handling resource or the second information handling resource as modified with the personality information.

In accordance with additional embodiments of the present disclosure, a method may include determining if personality information associated with an information handling resource of an information handling system is present on a personality module of the information handling system. The method may also include modifying the information handling resource or a second information handling resource to include the personality information in response to determining that the personality information associated with the information handling resource is present in the personality module. The method may further include executing the information handling resource or the second information handling resource as modified with the personality information.

In accordance with further embodiments of the present disclosure, an article of manufacture may include a computer readable medium and computer-executable instructions carried on the computer readable medium. The instructions may be readable by an information handling resource, and, when executed, for causing the information handling resource to: determine if personality information associated with an information handling resource of an information handling system is present on a personality module of the information handling system, in response to determining that the personality information associated with the information handling resource is present in the personality module, modify the information handling resource or a second information handling resource to include the personality information; and execute the information handling resource or the second information handling resource as modified with the personality information.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example personality module, in accordance with embodiments of the present disclosure; and

FIG. 3 illustrates a flow chart of an example method for vendor-specific customization of information handling resources of an information handling system, in accordance with embodiments of the present disclosure.

### DETAILED DESCRIPTION

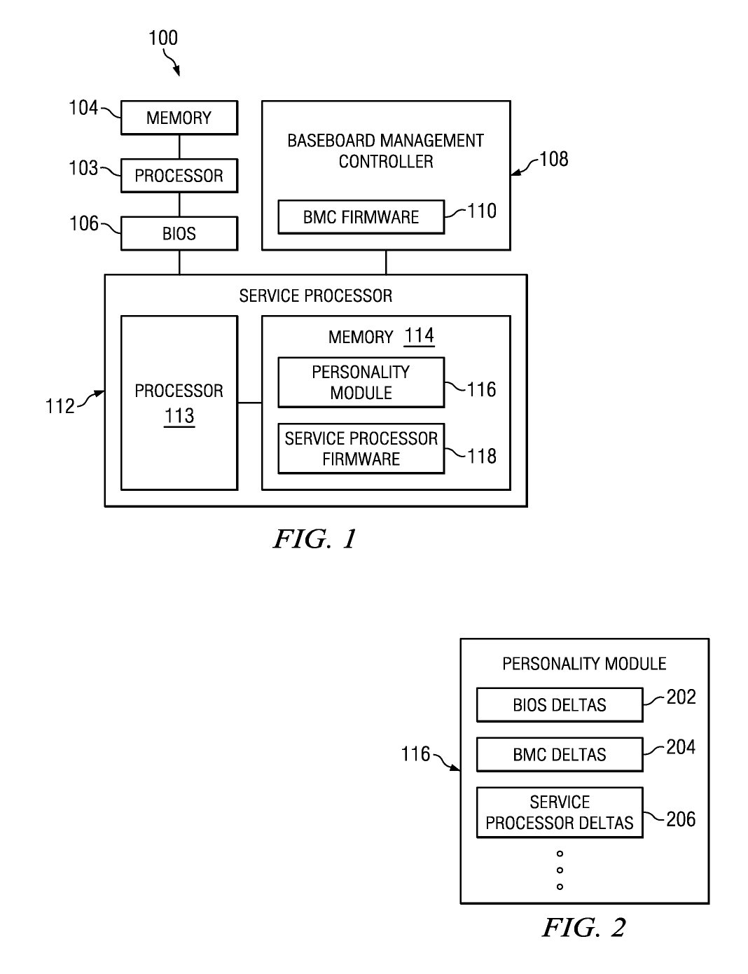

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), busses, memories, input-output devices and/or interfaces, storage resources, network interfaces, motherboards, peripherals, firmware, and/or any other components and/or elements of an information handling system.

Throughout this disclosure, references are made to “configuration” or “configuring” information handling systems. In this disclosure “configuration” and “configuring” may broadly refer to any establishment, setting, and/or modification of parameters affecting the operation, functionality, and/or behavior of an information handling system and/or any of its internal and/or external components. For example, and without limitation, “configuration” may include establishment, setting, and/or modification of parameters affecting initialization of an information handling system. As another example, and without limitation, “configuration” may include introduction, modification, and/or replacement of executable instructions relating to one or more components of an information handling system affecting operation, functionality, and/or behavior.

FIG. 1 illustrates a block diagram of an example information handling system 100, in accordance with certain embodiments of the present disclosure. In certain embodiments, information handling system 100 may be a server. In another embodiment, information handling system 100 may be a personal computer (e.g., a desktop computer or a portable computer). As depicted in FIG. 1, information handling system 100 may include a processor 103, a memory 104 communicatively coupled to processor 103, basic input/output system (BIOS) 106 communicatively coupled to processor 103, a baseband management controller communicatively coupled to processor 103, and a service processor 112 coupled to processor 103, BIOS 106, and/or baseband management controller 108. In addition, information handling system 100 may include information handling resources other than those depicted in FIG. 1.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 100.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off.

BIOS 106 may be communicatively coupled to processor 103 and may include any system, device, or apparatus configured to identify, test, and/or initialize information handling resources of information handling system 100. In some embodiments, BIOS 106 may be implemented as a program of instructions that may be read by and executed on processor 103 to carry out the functionality of BIOS 106. In these and other embodiments, BIOS 106 may comprise boot firmware configured to be the first code executed by processor 103 when information handling system 100 is booted and/or powered on. As part of its initialization functionality, BIOS code may be configured to set components of information handling system 100 into a known state, so that one or more applications 110 (e.g., an operating system or other application programs) stored on compatible media (e.g., memory 104) may be executed by processor 103 and given control of information handling system 100. In addition, BIOS 106 may be configured to communicate with service processor 112 to read and apply information stored in personality module 116, as described in greater detail below.

Baseboard management controller 108 may include any system, device, or apparatus configured to allow system administrators to manage information handling system 100 and/or monitor its operation and operation of its various information handling resources. Baseboard management controller 108 include, for example, a microcontroller embedded on a motherboard of information handling system 100 configured to manage an interface between system management software executing on information handling system 100 and information handling resources of information handling system 100. In certain embodiments, baseboard management controller 108 may be configured to provide an Intelligent Platform Management Interface (IPMI). In addition, baseboard management controller 108 may be configured to communicate with service processor 112 to read and apply information stored in personality module 116, as described in greater detail below. As shown in FIG. 1, baseboard management controller 108 may include BMC firmware 110. BMC firmware 110 may executable instructions to govern operation of baseboard management controller 108.

Service processor 112 may be communicatively coupled to processor 103, BIOS 106, baseboard management controller 108, and/or other information handling resources of information handling system 100 and may include any system, device, or apparatus configured to permit an administrator or other person to remotely monitor and/or remotely manage information handling system 100 (e.g., via an information handling system remotely connected to information handling system 100 via a network) regardless of whether information handling system 100 is powered on and/or has an operating system installed thereon. In certain embodiments, service processor 112 may allow for “out-of-band” control of information handling system 100, such that communications to and from service processor 112 are communicated via a management channel physically isolated from an “in band” communication channel for non-management traffic associated with information handling system 100. Thus, for example, if a failure occurs in information handling system 100 that prevents an administrator from remotely accessing information handling system 100 via its traditional network interface (e.g., operating system failure, power failure, etc.), the administrator may still be able to monitor and/or manage the information handling system 100 (e.g., to diagnose problems that may have caused failure) via service processor 112. In the same or alternative embodiments, service processor 112 may allow an administrator to remotely manage one or parameters associated with operation of information handling system 100 (e.g., power usage, processor allocation, memory allocation, security privileges, etc.). In certain embodiments, service processor 112 may include or may be an integral part of an access controller, Dell Remote Access Controller (DRAC) or an Integrated Dell Remote Access Controller (iDRAC). In addition, service processor 118 may be configured to communicate with service processor 112 to read and apply information stored in personality module 116, as described in greater detail below.

As depicted in FIG. 1, service processor 112 may include a processor 113 and a memory 114 communicatively coupled to processor 113. Processor 113 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 100. In some embodiments, processor 113 may be similar to processor 103. In other embodiments, processor 113 may be configured specifically for operation with service processor 112.

Memory 114 may be communicatively coupled to processor 113 and may include any system, device, or apparatus configured to retain program instructions and/or data for a period of time (e.g., computer-readable media). Memory 114 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off. In certain embodiments, memory 114 may store service processor firmware 118 firmware that includes executable instructions to govern operation of service processor 112.

In addition, as depicted in FIG. 1, memory 114 may have stored thereon a personality module 116. Personality module 116 may include vendor-specific information for BIOS 106, BMC firmware 110, service processor firmware 118, and/or other information handling resources of information handling system 100. For example, as is described in greater detail below, personality module 116 may include delta information for one or more information handling resources, such delta information including vendor-specific customizations to manufacturer-specific configurations of information handling resources. As a specific example, such delta information may include vendor-specific branding information, which may be used to overwrite manufacturer-specific branding information, such that vendor-specific identity is displayed to a display device associated with information handling system 100 when one or more information handling resources execute on information handling system 100.

FIG. 2 illustrates a block diagram of an example personality module 116, in accordance with embodiments of the present disclosure. As shown in FIG. 2, personality module 116 may include vendor-specific delta information associated with one or more information handling resources of information handling system 100. For example, personality module 116 may include BIOS delta information 202, BMC delta information 204, service processor delta information 206, and/or other delta information for other information handling resources of information handling system 100. BIOS delta information 202 may include vendor-specific customizations (e.g., branding information) to manufacturer-specific configurations of BIOS 106. Similarly, BMC delta information 204 may include vendor-specific customizations (e.g., branding information) to manufacturer-specific configurations of baseboard management controller 108 and/or BMC firmware 110. In addition, service processor delta information 206 may include vendor-specific customizations (e.g., branding information) to manufacturer-specific configurations of service processor 112 and/or service processor firmware 118.

Prior to delivery of information handling system 100 to an intended end user, a manufacturer or vendor may pre-install personality module 116 upon service processor 112. Each of one or more information handling resources (e.g., BIOS 106, baseboard management controller 108, BMC firmware 110, service processor 112, service processor 118, and/or others) may be configured to, upon initialization (e.g., at a start-up, power-on, and/or boot of information handling system 100), determine whether associated personality information associated with the particular information handling resource exists upon personality module 116. If such associated personality information exists for the particular information handling resource, the particular information handling resource may apply the associated personality information by modifying itself or another information handling resource to include the personality information. For example, if baseboard management controller 108 determines that associated personality information exists, and the personality information includes vendor-specific branding information, the baseboard management controller may modify itself or its associated BMC firmware 110 such that vendor-specific branding information may be displayed to a display device during execution of baseboard management controller 108, rather than display of manufacturer-specific branding information.

In some embodiments, in modifying itself or another information handling resource to apply personality information, an information handling resource may “permanently” modify itself or the other information handling resource with the applied personality information. In such embodiments, the information handling resource may, in future boot sessions, only apply associated personality information from personality module 116 if it determines that the associated personality information is more current than that presently applied. In other embodiments, the modification may only be applied for the present boot session, such that an information handling resources may apply associated personality information from personality module 116 in subsequent boot sessions.

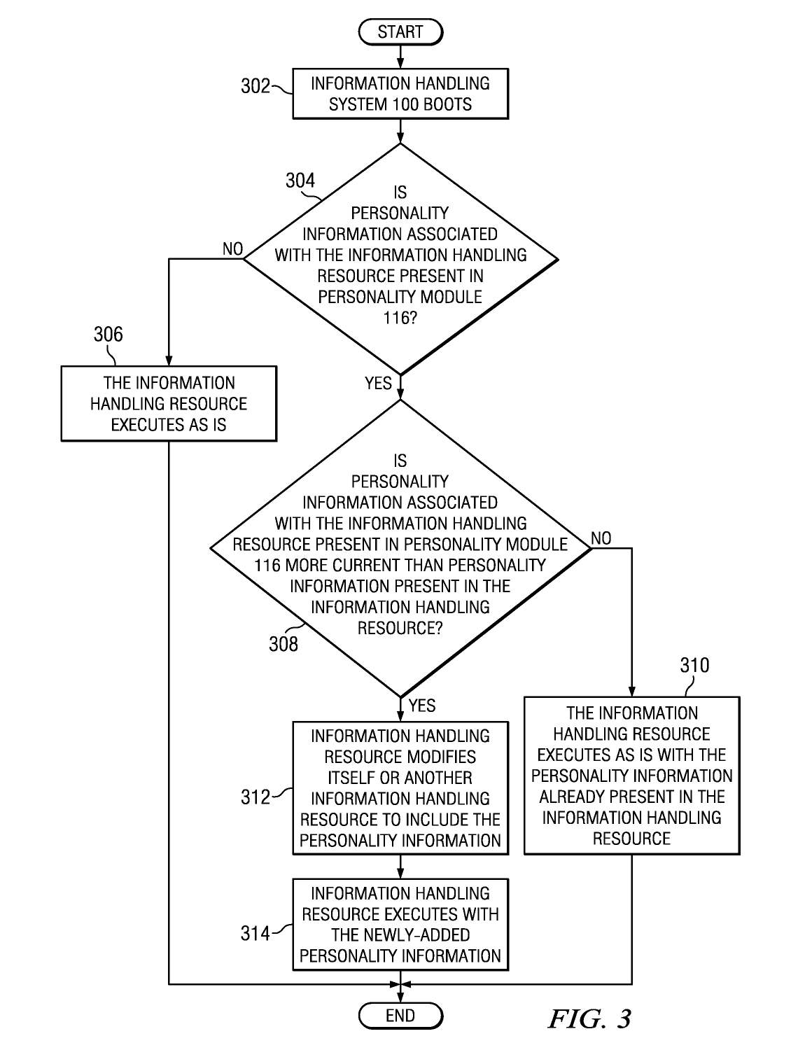

FIG. 3 illustrates a flow chart of an example method 300 for vendor-specific customization of information handling resources of an information handling system, in accordance with embodiments of the present disclosure. According to one embodiment, method 300 may begin at step 302. As noted above, teachings of the present disclosure may be implemented in a variety of configurations of information handling system 100. As such, the preferred initialization point for method 300 and the order of the steps 302-314 comprising method 300 may depend on the implementation chosen.

At step 302, information handling system 100 may boot. At step 304, an information handling resource of information handling system 100 (e.g., BIOS 106, baseboard management controller 108, BMC firmware 110, service processor 112, service processor 118, or another information handling resource) may determine if personality information associated with the information handling resource is present in personality module 116. If personality information associated with the information handling resource is present, method 300 may proceed to step 308. Otherwise, if personality information associated with the information handling resource is not present in personality module 116, method 300 may proceed to step 306.

At step 306, in response to a determination that personality information associated with the information handling resource is not present in personality module 116, the information handling resource may execute as is. After completion of step 306, method 300 may end.

At step 308, in response to determining that personality information associated with the information handling resource is present in personality module 116, the information handling resource may determine if the personality information associated with the information handling resource present in personality module 116 is more current than personality information present in the information handling resource. If the personality information associated with the information handling resource present in personality module 116 is more current than personality information present in the information handling resource, method 300 may proceed to step 312. If the personality information associated with the information handling resource present in personality module 116 is less current than personality information present in the information handling resource, method 300 may proceed to step 310.

At step 310, in response to determining that the personality information associated with the information handling resource present in personality module 116 is less current than personality information already present in the information handling resource the information handling resource may execute as is with the personality information already present in the information handling resource.

At step 312, in response to determining that personality information associated with the information handling resource present in personality module 116 is more current than personality information present in the information handling resource, the information handling resource may modify itself or another information handling resource to include the personality information.

At step 314, the information handling resource may execute with the newly-added personality information. After completion of step 314, method 300 may end.

Although FIG. 3 discloses a particular number of steps to be taken with respect to method 300, method 300 may be executed with greater or lesser steps than those depicted in FIG. 3. For example, in some embodiments personality information associated with an information handling resource may not be stored in the information handling resource across multiple boot sessions, meaning that the information handling resource may find and apply personality information for each boot session. In such embodiments, steps 308 and 310 may not be present in method 300, and method 300 may proceed from step 306 to step 312 if personality information associated with an information handling resource is present in personality module 116.

In addition, although FIG. 3 discloses a certain order of steps to be taken with respect to method 300, the steps comprising method 300 may be completed in any suitable order.

Method 300 may be implemented using information handling system 100 or any other system operable to implement method 300. In certain embodiments, method 300 may be implemented partially or fully in software and/or firmware embodied in computer-readable media.

Compared with traditional approaches, the methods and systems described above may provide for more efficient customization of information handling resources. For example, using the above-described methods and systems, vendor-specific personality information may be applied to manufacturer-standard information handling resources, without requiring that such manufacturer-standard information handling resources are manually modified to include such vendor-specific personality information. Instead, such information handling resources are configured to determine if personality information for the information handling resources exist in a personality module and, if so, apply such personality information to the information handling resources. Thus, as manufacturer-standard information handling resources are updated, such information handling resources may be delivered to an information handling system without manual addition of vendor-specific personality information, and the information handling resources may automatically apply such vendor-specific identity information.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a personality module having stored therein personality information associated with one or more information handling resources; and
an information handling resource communicatively coupled to the personality module and configured to:
determine if personality information associated with the information handling resource is present in the personality module;
in response to determining that the personality information associated with the information handling resource is present in the personality module, modify itself or a second information handling resource to include the personality information; and
execute the information handling resource or the second information handling resource as modified with the personality information.

2. An information handling system according to claim 1, the information handling resource further configured to determine during initialization of the information handling resource if personality information associated with the information handling resource is present in the personality module.

3. An information handling system according to claim 1, further comprising a service processor, and service processor comprising the personality module.

4. An information handling system according to claim 1, wherein the personality information includes at least one vendor-specific customization associated with a vendor of the information handling system, the vendor-specific customizations for modifying at least one manufacturer-specific configuration associated with a manufacturer of the information handling system.

5. An information handling system according to claim 4, the at least one vendor-specific customization comprising branding information associated with the vendor, and the information handling resource further configured to modify itself or the second information handling resource such that information handling resource displays to a display device associated with the information handling system the branding information.

6. An information handling system according to claim 1, the information handling resource comprising a Basic Input/Output System (BIOS) of the information handling system.

7. An information handling system according to claim 1, the information handling resource comprising a baseboard management controller of the information handling system.

8. An information handling system according to claim 7, the second information handling resource comprising baseboard management controller firmware.

9. An information handling system according to claim 1, the information handling resource comprising a service processor of the information handling system.

10. An information handling system according to claim 9, the second information handling resource comprising service processor firmware.

11. A method comprising:
determining if personality information associated with an information handling resource of an information handling system is present on a personality module of the information handling system;
in response to determining that the personality information associated with the information handling resource is present in the personality module, modifying the information handling resource or a second information handling resource to include the personality information; and
executing the information handling resource or the second information handling resource as modified with the personality information.

12. A method according to claim 11, further comprising determining during initialization of the information handling resource if personality information associated with the information handling resource is present in the personality module.

13. A method according to claim 11, wherein the personality module is an integral portion of a service processor of the information handling system.

14. A method according to claim 11, wherein the personality information includes at least one vendor-specific customization associated with a vendor of the information handling system, the vendor-specific customizations for modifying at least one manufacturer-specific configuration associated with a manufacturer of the information handling system.

15. A method according to claim 14, the at least one vendor-specific customization comprising branding information associated with the vendor, and the method further comprising modifying the information handling resource or the second information handling resource such that information handling resource displays to a display device associated with the information handling system the branding information.

16. A method according to claim 11, the information handling resource comprising a Basic Input/Output System (BIOS) of the information handling system.

17. A method according to claim 11, the information handling resource comprising a baseboard management controller of the information handling system.

18. A method according to claim 17, the second information handling resource comprising baseboard management controller firmware.

19. A method according to claim 11, the information handling resource comprising a service processor of the information handling system.

20. A method according to claim 19, the second information handling resource comprising service processor firmware.

21. An article of manufacture, comprising:
a computer readable medium;
computer-executable instructions carried on the computer readable medium, the instructions readable by an information handling resource, the instructions, when executed, for causing the information handling resource to:
determine if personality information associated with an information handling resource of an information handling system is present on a personality module of the information handling system;
in response to determining that the personality information associated with the information handling resource is present in the personality module, modify the information handling resource or a second information handling resource to include the personality information; and
execute the information handling resource or the second information handling resource as modified with the personality information.
